(19) United States
(12) Patent Application Publication
(10) Pub. No.: US 2011/0100002 A1
(43) Pub. Date: May 5, 2011

(54) PROCESS TO OBTAIN THERMAL AND KINETIC ENERGY FROM A GEOTHERMAL HEAT SOURCE USING SUPERCRITICAL CO2

(75) Inventors: John R. Muir, Lafayette, CA (US); Alan D. Eastman, Salt Lake City, UT (US); Mark P. Muir, Venice, CA (US)

(73) Assignee: GreenFire Partners LLC, Salt Lake City, UT (US)

(21) Appl. No.: 12/938,296

(22) Filed: Nov. 2, 2010

Related U.S. Application Data
(60) Provisional application No. 61/280,217, filed on Nov. 2, 2009.

(51) Int. Cl. F03G 4/00

(52) U.S. Cl. 60/641.2

(57) ABSTRACT

Methods and systems for extracting geothermal energy from an underground hot dry rock reservoir using supercritical carbon dioxide are disclosed. In a first step, the methods and systems utilize a heat exchanger in a binary system to heat a secondary fluid that is used to perform work. In a second step, the supercritical carbon dioxide is transferred to a pseudo turbine (e.g., a free-piston linear engine) to perform additional work through expansion.

### BACKGROUND OF THE INVENTION

1. The Field of the Invention

The present invention relates to the production of power and/or work from a geothermal heat source using supercritical carbon dioxide as the fluid medium in the geological formation.

2. The Relevant Technology

Various methods and systems exist for extracting heat from hot geothermal formations. For example one method uses water to hydraulically fracture hot rock to form a hot rock reservoir. Once a fractured reservoir has been formed, production wells are drilled to intersect the hot rock reservoir. Water is pumped into the reservoir through the injection well (i.e., typically the well used to fracture the hot rock). The injected water flows across the fractured surfaces of the hot dry rock and is heated. The geothermal heat is transferred to the surface by flowing the water upward through one or more production wells.

At the surface, the heat contained in the circulating geofluid is used to generate electrical power. Electrical power generation from geothermal sources may be accomplished generally in one of two different fashions: 1) by utilizing the geothermal heat to expand some working fluid (e.g., steam through a turbine), or 2) by utilizing a heated geothermal fluid indirectly to heat a separate working fluid which in turn drives a turbine (referred to as a “binary system”). Once the geothermal heat is extracted, the water is injected back into the reservoir. The flow is typically carried out in a pressurized, closed-loop circulating operation. This process is often referred to as “heat mining.”

Water-based geothermal systems generally have a geochemically determined temperature limit controlled by the critical point of water (384° C. and 22 MPa). As the critical point for water is reached and then surpassed, the enhanced dissolution of silica followed by retrograde precipitation above 384° C. presents a substantial obstacle to operating a hot dry rock geothermal reservoir at higher than the critical temperature for water. For hot dry rock reservoirs created in the most common igneous and metamorphic rocks and mixtures of the most common igneous and metamorphic rocks, where silica is present as either a primary or secondary (i.e., fracture-filling) mineral, the silica dissolution and re-precipitation problem occurs as the critical temperature for water is exceeded. Although drilling systems are capable of reaching rock temperatures in excess of 400° C., concerns about enhanced geochemical interactions arise in water-based hot dry rock geothermal energy systems at these temperatures.

Another problem with water-based hot dry rock geothermal energy systems is that they can consume large quantities of water. Water injected into the reservoir can leak into the surround rock formations. Drilling production wells to recapture all of the water injected into the reservoir can be cost prohibitive. Consequently water-based geothermal systems generally consume significant amounts of water, which makes these systems impractical in many dry climates.

The use of supercritical carbon dioxide as the geofluid avoids many of the problems associated with water-based systems. A methods for using supercritical carbon dioxide as the geofluid is described in U.S. Pat. No. 6,668,554, which is hereby incorporated herein by reference.

### BRIEF SUMMARY

The present invention relates to methods and systems for extracting geothermal energy from an underground hot dry rock reservoir using supercritical carbon dioxide. In a first step, the methods and systems utilize a heat exchanger in a binary system to heat a secondary fluid that is used to perform work. In a second step, the supercritical carbon dioxide is transferred to a pseudo turbine (e.g., a free-piston linear engine or turbo expander, or the like) to perform additional work through expansion.

In one embodiment, a system includes all or a portion of the following components: (i) an underground hot dry rock reservoir that includes heated supercritical carbon dioxide; (ii) a production well in fluid communication with the supercritical carbon dioxide in the hot dry rock reservoir; (iii) a heat exchanger that receives heated supercritical carbon dioxide from the production well and heats a secondary working fluid, the secondary working fluid is in fluid communication with a turbine that generates electrical power; (iv) a pseudo turbine that receives supercritical carbon dioxide from the heat exchanger and performs work using residual heat and/or pressure of the supercritical carbon dioxide, the pseudo turbine is configured to discharge a carbon dioxide fluid in a liquid or a supercritical state; and (v) an injection well in fluid communication with the supercritical carbon dioxide in the hot rock reservoir that recycles the carbon dioxide fluid from the pseudo turbine. The pseudo turbine can be any engine can be a free piston linear engine or a turbo expander such as a scroll expander.

The present invention also includes methods for extracting geothermal energy from an underground hot dry rock reservoir using supercritical carbon dioxide. In one embodiment the method can include all or a portion of the following steps: (a) providing a plurality of wells in fluid communication with an underground hot dry rock reservoir; (b) injecting a carbon dioxide fluid into the hot dry rock reservoir under supercritical conditions and allowing the supercritical carbon dioxide fluid to absorb heat; (c) removing at least a portion of the heated supercritical carbon dioxide fluid from the reservoir; (d) extracting heat from the heated supercritical carbon dioxide fluid using a heat exchanger that heats a secondary working fluid; and (e) expanding the heat-extracted supercritical carbon dioxide fluid to perform work thereby producing an expanded carbon dioxide fluid.

Because the working fluid in the pseudo turbine is supercritical carbon dioxide, the working fluid flows like a gas. In addition, because supercritical carbon dioxide is not a solvent for the inorganic materials found in igneous and metamorphic rocks, the working fluid in the pseudo turbine does not carry dissolved minerals that could be deposited on the surfaces of the pseudo turbine as would typically occur with a hot aqueous fluid. Thus, the use of supercritical carbon dioxide makes it possible to efficiently use the pseudo turbines in the geothermal systems of the present invention.

In addition, the expansion of the supercritical carbon dioxide in the pseudo turbine may be carried out so as to produce a liquid carbon dioxide or supercritical carbon dioxide, rather than gaseous carbon dioxide. Expanding the supercritical carbon dioxide without reaching a gas avoids the need to condense gaseous fluid, (unlike steam generation systems). With the carbon dioxide in a liquid or supercritical state, the carbon dioxide fluid can be economically pumped back into the hot rock reservoir. The combination of using a pseudo turbine with a heat exchanger in a binary system configuration produces more energy than thermal methods alone while still allowing closed loop cycling of the carbon dioxide working fluid.

These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawing. It is appreciated that this drawing depicts only illustrated embodiments of the invention and is therefore not to be considered limiting of its scope. The invention will be described and explained with additional specificity and detail through the use of the accompanying drawing in which:

FIG. 1 shows a schematic of a system for extracting energy from a geothermal heat source using a heat exchanger in a binary configuration and a pseudo turbine;

FIG. 2 illustrates a pseudo turbine that can be used in the system of FIG. 1;

FIG. 3 illustrates an alternative pseudo turbine that can be used in the system of FIG. 1.

### DETAILED DESCRIPTION

I. Systems For Extracting Geothermal Energy from Hot Dry Rock Reservoir

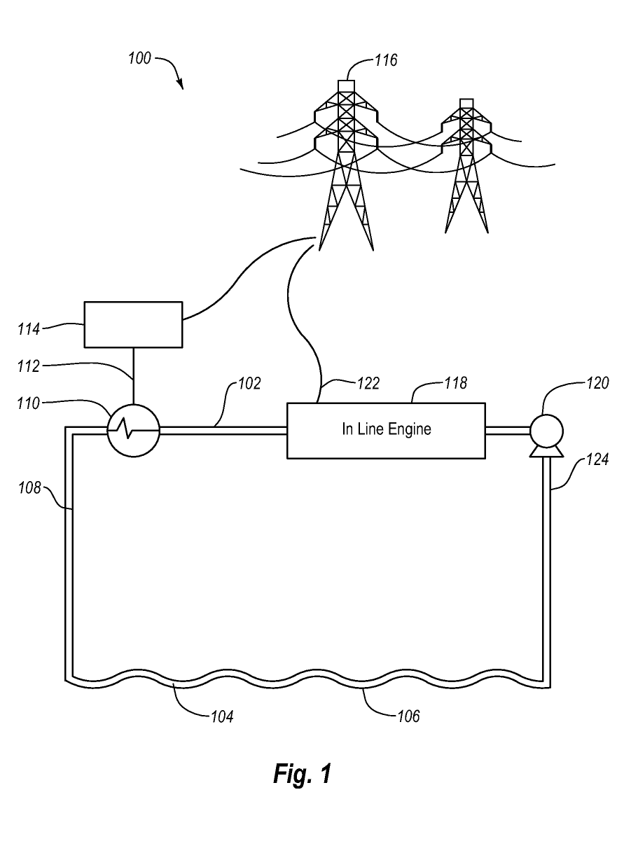

The present invention relates to the use of a pseudo turbine such as a free-piston linear engine or a turbo expander engine in a geothermal heat-mining system that utilizes supercritical carbon dioxide as the working fluid. FIG. 1 is a schematic illustration of a geothermal system incorporating a pseudo turbine according to one embodiment of the present invention. As shown in FIG. 1, a geothermal system 100 includes a closed loop fluid path 102. The fluid path 102 includes geothermally heated supercritical carbon dioxide fluid 104 in hot rock reservoir 106. The geothermally heated supercritical carbon dioxide is removed from hot rock reservoir 106 through production well 108. The geothermally heated supercritical carbon dioxide is introduced into a heat exchanger 110 to extract the geothermal energy by heating a secondary working fluid 112. The secondary working fluid 112 may be used in a power plant 114 to generate electrical power. The electrical power may be injected into an electrical grid 116.

The carbon dioxide fluid leaving heat exchanger 110 is at supercritical conditions, but is cooler than the carbon dioxide fluid entering heat exchanger 110 (i.e., partially cooled) and can have a significant amount of heat and pressure above supercritical conditions. The partially cooled carbon dioxide is transferred to a pseudo turbine 118 and expanded to perform work. In one embodiment, the work performed generates electricity 122, which can be injected into electrical grid 116 or utilized in an onsite process. In-line linear engine can also perform other work, such as mechanically powering a compressor.

The carbon dioxide fluid discharged from pseudo turbine 118 is preferably maintained as a liquid or supercritical carbon dioxide fluid. The use of a pseudo turbine allows expansion to be easily controlled in a manner that avoids expansion to a gas. The discharged liquid or supercritical carbon dioxide fluid can thus be pumped back into hot rock reservoir 104. In one embodiment, the carbon dioxide fluid is pumped into the hot rock reservoir 106 through injection well 124 using one or more pumps (e.g., pump 120).

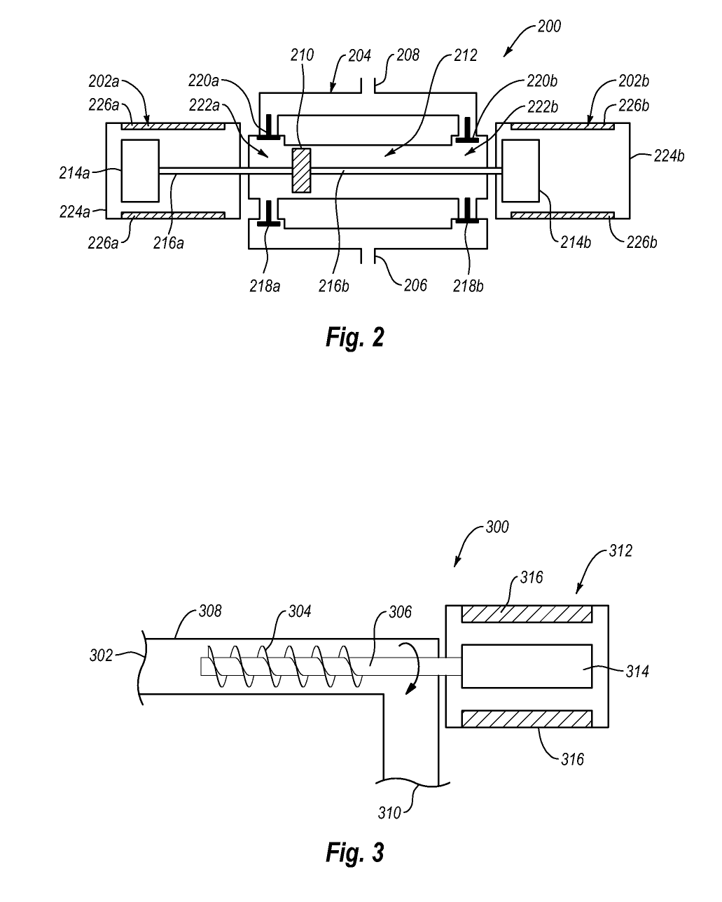

Pseudo turbine 118 may be a free piston linear engine or a turbo expander. FIGS. 2 and 3 illustrate examples of a free piston linear engine and scroll expander, respectively.

With reference to FIG. 2, a linear engine 200 is described. The linear engine 200 is configured as a linear alternator having two electrical generators 202a and 202b on opposite ends of pressure chamber 204. Pressure chamber 204 includes a high pressure inlet 206 that received the supercritical carbon dioxide fluid from the heat exchanger 110 (FIG. 1) and a low pressure outlet 208 where carbon dioxide fluid is discharged from the linear alternator. Pressure chamber 204 includes a piston 210 that travels in piston chamber 212. Piston 210 creates a high pressure seal with the walls of chamber 212, sufficient to withstand the pressure in carbon dioxide fluid received from heat exchanger 110. Piston 210 may be mechanically coupled one or more linear alternators. For example, piston 210 may be mechanically coupled to a linear moving magnet 214a of generator 202a through shaft 216a. Piston 210 is also connected to linear moving magnet 214b of generator 202b through shaft 216b.

Pressure chamber 204 includes four or more valves that allow high pressure to be alternatively applied to opposite sides of piston 210. High pressure valve 218a is in fluid communication with chamber 212 at end 222a and in fluid communication with high pressure inlet 206. High pressure valve 218b is in fluid communication with chamber 212 at end 222b and also in fluid communication with high pressure inlet 206.

Low pressure valve 220a is in fluid communication with chamber 212 at end 222a and in fluid communication with low pressure outlet 208. Low pressure valve 220b is in fluid communication with chamber 212 at end 222b and in fluid communication with low pressure outlet 208.

During operation, piston 210 is caused to continuously move back and forth between ends 222a and 222b by opening a high pressure valve and a low pressure valve on opposite ends 222a and 222b. For example, to force piston 210 toward, end 222b, valve 218a and valve 220b are opened while valves 220a and 218b remain closed. This configuration creates a pressure differential across piston 210 with high pressure at end 222a and low pressure at end 222b. The pressure differential forces piston 210 toward end 222b. To cause piston 210 to move back toward end 222a, valves 218a and 22b are closed and valves 218b and 220a are opened. This configuration of the valve reverses the pressure differential across piston 210 and forces piston 210 toward end 222a. The opening and closing of sets of valves is timed to move piston 210 back and forth repeatedly.

As piston 210 moves back and forth linear moving magnets 214a and 214b move back and forth within housing 224a and 224b, respectively. Housing 224a and 224b includes a stator such as coiling 226a that surround linear moving magnet 214a. Linear moving magnet 214a includes a magnet such that the back and forth movement of linear moving magnet 214a within coil 226a, produces electrical power and a corresponding load on piston 210. Similarly, linear moving magnet 214b includes a magnet that moves back and forth within coil 226b to produce electrical power, which applies a load to piston 210. The use of two opposing electrical generators is not required, but the use of opposing generators can reduce vibrations, thereby reducing wear and/or maintenance.

The linear engine can be used to perform work other than generating electrical power. For example, the linear engine can be used to run a compressor that compresses another fluid or runs a cryogenic system. The methods and systems for applying a linear motion to operate a compressor and/or cryogenic system are known to those skilled in the art. The linear motion can also be converted to rotational motion and utilized using known techniques for performing work from rotation motion.

FIG. 3 illustrates an alternative embodiment in which a turbo expander 300 is used as a pseudo turbine. Turbo expander 300 includes an inlet 302 in fluid communication with heat exchanger 110. Inlet 302 receives a supercritical carbon dioxide fluid at high pressure and temperature. The scroll expander includes a scroll piece 304 within conduit 308. Scroll piece 304 rotates in response to high pressure at inlet 302 and low pressure at outlet 310. The pressure differential causes the fluid to expand, which moves scroll piece 304, thereby rotating shaft 306. Shaft 306 can extend out of conduit 308 and perform useful work. While a simple schematic of a scroll expander is shown in FIG. 3, those skilled in the art will recognize that other configurations of turbo expanders may be used, including configurations known in the art.

A load is applied to the rotation of shaft 306 to perform work. The work may be compression, electrical power generation, or other work such as mechanical work. FIG. 3 illustrates a generator coupled to shaft 306 for generating electrical power (which can be injected into electrical grid 116 as shown in FIG. 1). In one embodiment, generator 312 includes a rotor 314 that rotates within a stator 316 of generator 312 to produce power.

II. Methods For Extracting Geothermal Energy from Hot Dry Rock Reservoir

The present invention also includes methods for using carbon dioxide to extract heat from a geothermal source using a heat exchanger and then secondarily expanding the carbon dioxide fluid in a pseudo turbine such as a free piston engine or a turbo expander.

The methods of the invention can be used for production of geothermal energy from hot dry rock reservoirs using supercritical carbon dioxide as the working fluid. The methods also provide a means for sequestering carbon dioxide that is produced in a combustion process such as a coal-fired power plant, thereby reducing emissions of gasses believed to contribute to anthropogenic global warming.

As mentioned, the methods of the invention can include one or more of the following steps: (a) providing one or more injection wells in fluid communication with an underground hot dry rock reservoir; (b) injecting a carbon dioxide fluid into the hot dry rock reservoir under supercritical conditions and allowing the supercritical carbon dioxide fluid to absorb heat; (c) removing at least a portion of the heated supercritical carbon dioxide fluid from the reservoir through one or more production wells; (d) extracting heat from the heated supercritical carbon dioxide fluid using a heat exchanger that heats a secondary working fluid; and (e) expanding the heat-extracted supercritical carbon dioxide fluid to perform work thereby producing an expanded carbon dioxide fluid; and (f) pumping the expanded carbon dioxide back into the hot dry rock.

The one or more injection wells may be provided by drilling using any suitable method known in the art. A single injection wellbore is generally adequate for injection. Depths are selected to reach a level where there is sufficient heat in the rock to make successful, cost effective thermal production practical. Generally, depths in the range from about 1,000 feet (below surface debris and sediments and sedimentary rocks) to about 30,000 feet can be used, depending upon underground thermal conditions.

The injection well is used to inject carbon dioxide fluid into a hot dry rock reservoir. In most cases, the permeability of the naturally occurring hot rock is not sufficient to be used as a reservoir. To increase the permeability of the hot rock reservoir, the rock can be hydraulically fractured. The conditions for fracturing hot dry rock to form the reservoir are typically different than the on-going operating conditions of the system. For example, the working fluid may be different and the pressures will be higher.

Hydraulic fracturing can be carried out in deep regions of igneous or metamorphic rock or in deep region of limestone or other sedimentary rock using a fracturing fluid. Generally, best results are achieved from fracturing deep regions of essentially impermeable, hot, basement crystalline rock below sedimentary rock layers. For example, in the methods of the present invention the rock that can be fractured may be deep crystalline rock formations such as granite, granodiorite, diorite, mafic igneous rocks, metamorphic equivalents of any of these, or other crystalline rocks.

The fracturing fluid may be water or other fracturing fluid typically used in the oil and gas industry to fracture geological formations of rock. Or alternatively the fracturing fluid may be supercritical carbon dioxide fluid. Combinations of various fluids and/or suspensions may be used to achieve a desired density and/or flowability. The fracturing fluid may include particulates that aid in sustaining the fractured pathways of the reservoir, once the highest pressures are released, thereby ensuring that the reservoir maintains a high volume during on-going operation.

Fracturing may be carried out by pumping the fluid at high pressure into the injection well. The rate of pumping can be in a range from about 20 to about 60 kg/s using commercially available pumping equipment. Pumping equipment suitable for creating pressures in the range from about 1,000 psi to about 15,000 psi (at the surface) are generally sufficient to fracture most formations.

The size and temperature of the hot rock reservoir and its permeability determine in part how much heat can be geothermally extracted using the heat exchanger and the pseudo turbine. The hot rock reservoir can be created at a depth capable of heating supercritical carbon dioxide to a temperature of at least 120° C., preferably at least 130° C., and more preferably at least 140° C. In general, hotter temperatures are desired such that more work can be extracted. Upper temperatures are typically limited by drilling costs and the cost to manufacture heat exchangers that can withstand the temperature of the working fluid. Thus the temperature of the working fluid can be less than 1000° C., less than 800° C., or less than 600° C. Underground rock temperatures in the range from about 150° C. to about 500° C. are considered more useful in many of the methods of the invention.

The carbon dioxide fluid can be injected through the well by any convenient means such as with a positive displacement or centrifugal pump. The carbon dioxide fluid may also be injected into the packed-off interval of an open hole wellbore using any suitable means such as a high-pressure tubing string. Initially, as the pressure in the packed-off interval is rapidly increased, one or more of the more favorably oriented natural joints intersecting the wellbore starts to open under a combination of tensile (hoop) stresses at the wellbore surface and normal opening stresses from fluid invasion into the hydrothermally sealed natural joints (which are somewhat more permeable than the adjacent unjointed rock). In a region where the natural fractures in the rock are predominantly vertical, lower pumping pressure is generally necessary than if the pre-existing fractures or joints in the rock are predominantly inclined from the vertical. As pumping continues, the natural fractures or joints progressively open and interconnect, forming a multiply connected region of pressure-dilated joints in the rock mass surrounding the packed-off wellbore interval, thus creating the fractured hot dry rock reservoir region. The fracture volume of the reservoir can be as much as ten times or more greater than the original microcrack pore volume of the un-fractured rock formation. Confined reservoir regions as large as a cubic kilometer or more can be made by hydraulic fracturing.

The formation of the reservoir can require a period of time. For example, the fracturing period can last for injection periods from a few hours to several months, depending upon the characteristics of the in situ stress field, the extent and orientation of fractures and joints already existing in the rock mass to be fractured, the resistance to flow in the network of interconnected fractures, the orientation of joint sets in the region to be fractured, and, most importantly, upon the desired size of the confined reservoir to be created. Generally an injection period in the range from about week to about three months is adequate. The duration of the fracture period may also depend on the fracturing fluid used. Where water is used as a fracturing fluid, injection of a carbon dioxide fluid for a period of time will be needed to extract the water from the reservoir. However, this two step formation process can be advantageous since fracturing with water uses techniques that have been well-developed in the oil and gas drilling industry and can thus be readily implemented in the present invention.

During the period of time in which water is being extracted from the reservoir, additives can be incorporated into the fracturing fluid to inhibit corrosion of casing, piping, pumping equipment, and power generation plant equipment such as heat exchangers. Once the water is removed to form the hot dry rock reservoir, problems with mineral precipitates are diminished or eliminated since minerals such as silica and chlorides are generally not soluble in supercritical carbon dioxide.

If the hot dry rock reservoir is being created in sedimentary rock or other formations which contain methane and other hydrocarbons, it may be advantageous to incorporate a separation step to remove hydrocarbons. Separation of the hydrocarbons from the supercritical carbon dioxide fluid can be accomplished using any conventional method such as separation with propylene carbonate membranes or by chilling the mixture to distill out the hydrocarbons.

Once the hot rock reservoir is formed, the pressure of supercritical carbon dioxide fluid is reduced to a pressure at which the system is stabilized with no further fracture extension, i.e., no more rock is being fractured at the periphery of the reservoir and, therefore, the reservoir is no longer being enlarged. In this manner a large region of fractured rock bounded by surrounding almost-impermeable un-fractured rock is created (i.e., the confined hot dry rock reservoir). The pressure in the hot rock reservoir should be at supercritical conditions. (i.e., 1,073 psi and 80° F.). The pressure can generally be in a range from about 1,073 to about 10,000 psi, preferably 1,500-8,000 psi, and most preferably 2,000-6,0000 psi.

After reducing the pressure from the fracturing pressure to ongoing system pressure, the periphery of the hot dry rock reservoir may still slowly diffuse supercritical carbon dioxide outward to adjacent field with much lower pressure. The pre-existing water-filled network of interconnected microcracks in the surrounding rock mass may be slowly flushed with the supercritical carbon dioxide fluid, and the pore fluid is dissolved, leaving behind mineral precipitates which tend to partially plug the microcrack porosity and slowly seal the reservoir boundaries.

The slow loss of carbon dioxide from diffusion and/or precipitation can necessitate supplying additional carbon dioxide to the system. The source of the carbon dioxide fluid can be a natural source such as a natural deposit of carbon dioxide, or the carbon dioxide fluid can be provided from a hydrocarbon combustion process such as a coal-fired power plant. Where the carbon dioxide is provided from a hydrocarbon combustion process, the carbon dioxide may benefit from a separation process that separates carbon dioxide from nitrogen or the carbon dioxide can be collected from an oxyfired power plant that produces highly concentrated carbon dioxide. Thus, using carbon dioxide as the geofluid has the additional advantage of providing a way to sequester carbon dioxide from flue gases or other industrial process effluents. For example, small quantities of carbon dioxide that escapes from the hot rock reservoir into surround rock is lost in the surrounding hot rock

For production of thermal energy from the hot dry rock reservoir, one or more production wellbores are drilled into the fractured zone using any suitable drilling method. Since the deep earth stress field is normally anisotropic, the pressure-stimulated reservoir region will tend to be elongated in some direction, but still symmetrical about the injection well that was used to create the fractured region that is the reservoir. Therefore, in most cases it will be most economical to access the reservoir with a plurality of production wells surrounding the injection well. For example, in ellipsoidal-shaped hot dry rock reservoirs, production wells could be drilled at each end at the greatest distance from the injection well. Generally presently preferred are two production wells drilled to penetrate the reservoir near either end of the elongated region. This three-well (one injection, two production) strategy usually is most cost effective. Although, in extended fields, other arrangements such as the five-spot arrangement can be used.

In a typical production process in accordance with the invention, following the drilling of one or more production wells, pressurized supercritical carbon dioxide fluid is injected into the reservoir through at least one injection well. The same wellbore used to fracture the rock to form the reservoir is generally used as the injection wellbore. Initially, sufficient supercritical carbon dioxide fluid to re-pressurize the reservoir, to establish circulation, and to make up for supercritical carbon dioxide fluid diffusing into the rock mass surrounding the reservoir region, is introduced into the injection well.

The supercritical carbon dioxide fluid is heated by transfer of energy from the hot rock surfaces it comes into contact with in the reservoir. As the supercritical carbon dioxide fluid is heated it expands to some extent, losing density.

The very significant difference in the density of the cold injected supercritical circulating fluid in the injection wellbore (which can be as much as about 1.0 g/cc for carbon dioxide) and the density of the hot produced circulating fluid in the production wellbore or wellbores (which can be as little as about 0.3 g/cc for carbon dioxide) provides a buoyant drive or thermo-siphoning of the geofluid which greatly reduces the required circulating pumping power compared to that required for geofluid circulation in a comparable water-based hot dry rock geothermal energy system. The difference in density can also make up for a significant portion of the pressure drop across the linear engine. The density difference increases with increasing temperature, which typically depends on depth. The temperature difference may preferably be greater than 25° C., 35° C. and most preferably greater than 45° at a pressure greater the 1073° C.

The supercritical carbon dioxide fluid circulating through the system is pumped down at least one injection well into the reservoir region with sufficient pressure to achieve an appropriate level of reservoir pressurization that will cause carbon dioxide fluid to be produced in the production well, thereby maintaining circulation. The pressure drop across the hot rock reservoir and the work performed in the pseudo turbine of the fluid circulation system and a small pressure drop across the heat exchanger are largely responsible for the pumping pressure needed to maintain cycling. However, the thermo-siphon effect reduces that amount of pumping pressure required because of the pressure generated from the more dense cool fluid in the injection well compared to the less dense heated fluid in the production well.

Heated supercritical carbon dioxide surface conduits of a kind and configuration known in the art may be used to convey the heated supercritical carbon dioxide fluid from the well head to the heat exchanger and subsequently to the pseudo turbine.

The heat exchanger is used in a binary system to extract geothermal energy. Supercritical carbon dioxide is caused to flow through the heat exchanger and warm a secondary working fluid. Heat exchangers known in the art can be used. Typically the supercritical carbon dioxide fluid is flowed in a counter flow with the secondary fluid such that secondary working fluid exiting the heat exchanger is in contact with newly introduced (and therefore the hottest) carbon dioxide fluid. Conversely, the input of the secondary fluid (which is typically the coldest fluid) first contact the carbon dioxide fluid near the outlet of the carbon dioxide fluid.

The secondary working fluids can be any fluid suitable for use in the heat exchanger and that can be used to perform work when heated. Examples of secondary working fluids that can be used in the binary process of the present invention include, but are not limited to, pentane, isobutane, a halogenated hydrocarbon refrigerant, liquid ammonia or another suitable binary-cycle working fluid.

The heated secondary working fluid can be used in any heat driven process to perform work. For example, the secondary fluid may be used to generate electrical power in a turbine. The secondary working fluid may be vaporized and the expanding vapor used to spin the turbine while losing pressure and temperature. The expanded gaseous secondary fluid may then be circulated through a cooling tower where it is condensed to the liquid phase. The liquid phase secondary working fluid may then be pumped back into the heat exchanger where it is once again heated and then vaporized to continuously drive the turbine. The power generated from the turbine may be used on site or injected into an electrical grid for commercial use.

While the present invention has been described as showing the heat exchanger used for power generation, those skilled in the art will recognize that all or a portion of the heat from the heat exchanger may be used in other processes, such as, but not limited to, space heating, preheating materials for chemical processes, drying pumice and minerals mined in a way that produces wet products, heating greenhouses, drying crops, heating water, and for any other direct-heat application requiring a moderate-temperature hot fluid.

The temperature drop across the heat exchanger can be significant and is optimally as much as possible. For example, the temperature drop can be more than 25° C., 50° C., 100° C., or even greater than 150° C.

The carbon dioxide fluid exiting the heat exchanger is maintained at supercritical conditions such that it can be introduced into the in-line heat exchanger as a supercritical fluid. The supercritical carbon dioxide is then expanded to perform work. The work performed can be power generation, gas compression, mechanical work, or any process known in the art that can utilize the motion of a linear engine or turbo expander.

Because the carbon dioxide fluid in the pseudo turbine is supercritical carbon dioxide, the viscosity and flowability of the carbon dioxide fluid is similar to a gas, but its density is similar to a liquid. While the molar heat capacity is not as high as water, supercritical carbon dioxide avoids many problems associated with using geothermal source of steam in a linear engine. Because supercritical carbon dioxide is not a solvent for the inorganic materials found in igneous and metamorphic rocks, the supercritical carbon dioxide in the pseudo turbine cannot carry these minerals to the pseudo engine. The inability of supercritical carbon dioxide fluid to dissolve and transport mineral constituents from the geothermal reservoir to the surface eliminates mineral scaling effects in the pseudo turbine and surface piping.

The work performed in the pseudo turbine depends on the efficiency of the engine and the pressure drop. Free piston engines and turbo expanders are preferred for their efficient conversion of pressure to work and for the controlled expansion that can be performed. For example, free piston engines and turbo expanders can be readily used to maintain the carbon dioxide fluid in a liquid or supercritical state as it exits the pseudo turbine.

Although not preferred, the carbon dioxide fluid may be expanded to a gas and discharged into the atmosphere following expansion in the pseudo turbine. However, more preferably, the carbon dioxide fluid is maintained in a closed loop system where it is re-injected into the hot dry rock reservoir. As mentioned above, pumping equipment known in the art can be used to pump the expanded carbon dioxide fluid back into the hot dry rock reservoir in a continuous pressurized cycle.

Because the energy produced from the systems of the present invention use geothermal energy as the heat source, the methods and systems of the invention can produce power or work with nearly no carbon emissions. In addition, supercritical carbon dioxide will likely leak into the surrounding rock from the hot rock reservoir, thereby escaping from and/or expanding the hot rock reservoir. This carbon dioxide leakage can be somewhat desirable as it is a form or carbon dioxide sequestration.

For certain types of igneous and metamorphic rocks comprising the rock mass, the hot supercritical carbon dioxide diffusing outward from the hot dry rock reservoir region may be chemically bound up in the rock by carbonating the contained calcic feldspars (e.g., labradorite or anorthite). That is, for supercritical carbon dioxide diffusing through hot, microcracked felsic or silicic rocks (e.g., granite, granodiorite, diorite or gabbro), the carbon dioxide reacts with the contained calcic feldspars, producing calcium carbonate as a precipitate with clays and other geochemically altered materials. Thus, the outward diffusion of carbon dioxide provides for long-term sequestration, with the carbon dioxide being chemically bound up in the rock mass. This eliminates any environmental consequences from the possible slow leakoff of carbon dioxide from the near-reservoir region to the environment. Thus, the systems and methods of the invention can mitigate the anthropogenic induced increases of atmospheric carbon dioxide by creating a permanent carbon dioxide sink.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for extracting geothermal energy from an underground hot dry rock reservoir using supercritical carbon dioxide:
an underground hot dry rock reservoir having heated supercritical carbon dioxide therein;
a production well in fluid communication with the supercritical carbon dioxide in the hot dry rock reservoir;
a heat exchanger that receives heated supercritical carbon dioxide from the production well and heats a secondary working fluid, wherein the secondary working fluid is in fluid communication with a turbine that generates electrical power;
a pseudo turbine that receives supercritical carbon dioxide from the heat exchanger and performs work using residual heat and/or pressure of the supercritical carbon dioxide, wherein the pseudo turbine is configured to discharge a carbon dioxide fluid in a liquid or a supercritical state; and
an injection well in fluid communication with the supercritical carbon dioxide in the hot rock reservoir, the injection well receiving supercritical carbon dioxide or liquid carbon dioxide from the pseudo turbine.

2. A system as in claim 1, wherein the pseudo turbine is a turbo expander.

3. A system as in claim 2, wherein the turbo expander is a scroll expander.

4. A system as in claim 1, wherein the pseudo turbine is a free piston engine.

5. A system as in claim 4, wherein the free piston engine is a linear alternator.

6. A system as in claim 1, further comprising a pump configured to pump the carbon dioxide fluid from the pseudo turbine into the injection well.

7. A system as in claim 1, wherein the work performed by the pseudo turbine includes compressing a fluid.

8. A system as in claim 1, wherein the work performed by the pseudo turbine includes generating electrical power.

9. The method as recited in claim 1 wherein the hot dry rock reservoir is at a depth in the range of from 1,000 feet to 30,000 feet.

10. A method for extracting geothermal energy from an underground hot dry rock reservoir, comprising the steps of:
(a) providing a plurality of wells in fluid communication with an underground hot dry rock reservoir;
(b) injecting a carbon dioxide fluid into the hot dry rock reservoir under supercritical conditions and allowing the supercritical carbon dioxide fluid to absorb heat therefrom;
(c) removing at least a portion of the heated supercritical carbon dioxide fluid from the reservoir;
(d) extracting heat from the heated supercritical carbon dioxide fluid using a heat exchanger that heats a secondary working fluid; and
(e) expanding the heat-extracted supercritical carbon dioxide fluid to perform work thereby producing an expanded carbon dioxide fluid.

11. The method as recited in claim 1, wherein at least a portion of the carbon dioxide fluid injected into the reservoir is obtained from the expanded supercritical carbon dioxide produced in step (e), thereby recycling carbon dioxide fluid through steps (b)-(e).

12. The method as recited in claim 2 wherein the carbon dioxide fluid is recycled for a period of at least 48 hours.

13. The method of claim 1, wherein the step of expanding the heat-extracted supercritical carbon dioxide fluid is carried out in a free piston linear engine.

14. The method of claim 1, wherein the step of expanding the heat-extracted supercritical carbon dioxide fluid is carried out in a turbo expander.

15. The method as recited in claim 1 wherein the secondary working fluid is used to generate power in a surface power plant.

16. The method as recited in claim 1, wherein hot dry rock reservoir is formed by fracturing an underground hot dry rock formation.

17. The method as recited in claim 1 wherein the hot dry rock reservoir is at a depth in the range of from 1,000 feet to 30,000 feet.

18. The method as recited in claim 1 wherein the hot dry rock of the hot dry rock reservoir has a temperature in the range from 120° C. to 1,000° C.

19. The method as recited in claim 5 wherein the temperature of the hot dry rock of the hot dry rock reservoir has a temperature in the range of from about 150° C. to 600° C.

20. The method as recited in claim 1 wherein the fluid is injected at a pressure in the range from 1,000 psi to 15,000 psi.
